(19) United States
(12) Patent Application Publication
(10) Pub. No.: US 2005/0203823 A1
(43) Pub. Date: Sep. 15, 2005

(54) Method for encouraging extended holding periods of publicly traded equity shares

(76) Inventor: Thomas W. Cushing, Hobe Sound, FL (US)

Correspondence Address: Scott R. Foster;Pandiscio & Pandiscio, P.C., 470 Totten Pond Road, Waltham, MA, 02451-1914, US

(21) Appl. No.: 11/076,526

(22) Filed: Mar. 8, 2005

Related U.S. Application Data
(60) Provisional application No. 60/553,061, filed on Mar. 15, 2004.
(60) Provisional application No. 60/561,952, filed on Apr. 14, 2004.

(51) Int. Cl. G06F 17/60

(52) U.S. Cl. 705/36

(57) ABSTRACT

A method for encouraging extended holding periods of securities includes applying to the securities one or more benefits contingent upon a selected length of time in which the securities are retained by an owner of the securities.

### CROSS-REFERENCE TO RELATED APPLICATION

This application claims the benefit of U.S. Provisional Patent Application Ser. No. 60/553,061, filed Mar. 15, 2004, in the name of Thomas W. Cushing, and of U.S. Provisional Patent Application Ser. No. 60/561,952, filed Apr. 14, 2004, in the name of Thomas W. Cushing.

### BACKGROUND OF THE INVENTION

1. Field of the Invention

The invention relates to the issuance, purchase and sale of publicly traded securities, such as equity shares, and is directed more particularly to encouraging extended holding periods of such securities by rewarding the holders of securities for the extended retention thereof.

2. Description of the Prior Art

Dividend payments represent an important part of equity value for investors. Other equity attributes, such as a shareholder's right to vote, are also valuable.

Turnover (i.e. the rate of change of ownership) in publicly traded equity shares is by some measures considered excessive in relation to the role that such shares are intended to play in the capital formation and allocation process. Capital is used most efficiently when it is allocated judiciously to its best uses and in a manner that reflects the real and substantial cost of changing capital allocation. Corporate and public interests are not well served when the ownership of a public company changes hands multiple times per year, as is currently often the case. The decreasing costs (such as decreasing commision rates and reductions in minimum bid-offer spreads) of trading have added to the volativity of equity trading.

Speculative trading activity is a key driver of the excessive share turnover noted above. Speculative trading tends to drive up share price volatility. All else being equal, a security with higher price volatility will have a higher risk premium associated with it, and therefore will probably have a lower price. By definition, a lower share price represents a higher cost of capital to an issuer. Therefore, absent a demonstrable offsetting benefit, high price volatility represents a further drag on investment returns, and therefore on the economy. Increased volatility can also drive up the costs of investing, especially so-called “indirect” transaction costs. Such costs manifest themselves when the price of a stock moves adversely while an investor is attempting to transact it.

The basic security classes (debt, preferred equity, common equity) have been around for hundreds of years with little change. More recently (in the past thirty years or so), financial intermediaries have created a wide array of new security types and derivatives, such as listed options, asset-back securities, convertible bonds and preferred stock, Treasury “strips”, and financial futures. These and other innovations have helped investors participate in new sources of risk, tailor previously available sources of risk, and achieve different blends of income vs- capital appreciation, for example. However, little has been done to modify the basic terms of common equity ownership in ways that might enhance shareholder value and benefit the economy.

There is thus a need for a method for issuing equity shares, and the like, in such a manner as to create an incentive for investors to lengthen their holding periods, permitting public companies to reduce turnover and share price volatility, thereby increasing the market value of the shares and lowering their cost of capital, benefiting issuers, investors, and the economy.

### SUMMARY OF THE INVENTION

Accordingly, an object of the invention is to provide a method for encouraging extended holding periods of equity shares.

With the above and other objects in view, a feature of the invention is the provision of a method for encouraging extended holding periods of securities, such as equity shares, and the like, the method including the steps of applying to the securities a benefit contingent upon the length of time the shares are retained by an owner of the shares.

In accordance with a further feature of the invention, there is provided a method for encouraging extended holding periods of securities, such as equity shares, and the like, the method including the steps of assigning to each of the shares a specified benefit due to the owner of the share, and increasing the benefit in accordance with a specified time period of ownership by the owner.

In accordance with a still further feature of the invention, there is provided a method for increasing the value of a security issued or to be issued by an issuer and held or to be held by an owner, so as to encourage retention of the security by the owner. The method includes the steps of assigning to the security a specified first benefit, and a specified second benefit more valuable than the first benefit, and specifying a selected time period between a first date on which the owner obtains the security and a second date following the first date and on which the owner still returns the security acquired on the first date, for the second benefit to be realized.

The above and other features of the invention, including various novel details of and combinations of steps, will now be more particularly described with reference to the accompanying drawing and pointed out in the claims. It will be understood that particular methods embodying the inventions are shown and described by way of illustration and not as a limitation of the invention. The principles and features of this invention may be employed in various and numerous embodiments without departing from the scope of the invention.

### BRIEF DESCRIPTION OF THE DRAWING

Reference is made to the accompanying drawing in which is shown an illustrative embodiment of the invention, from which its novel features and advantages will be apparent.

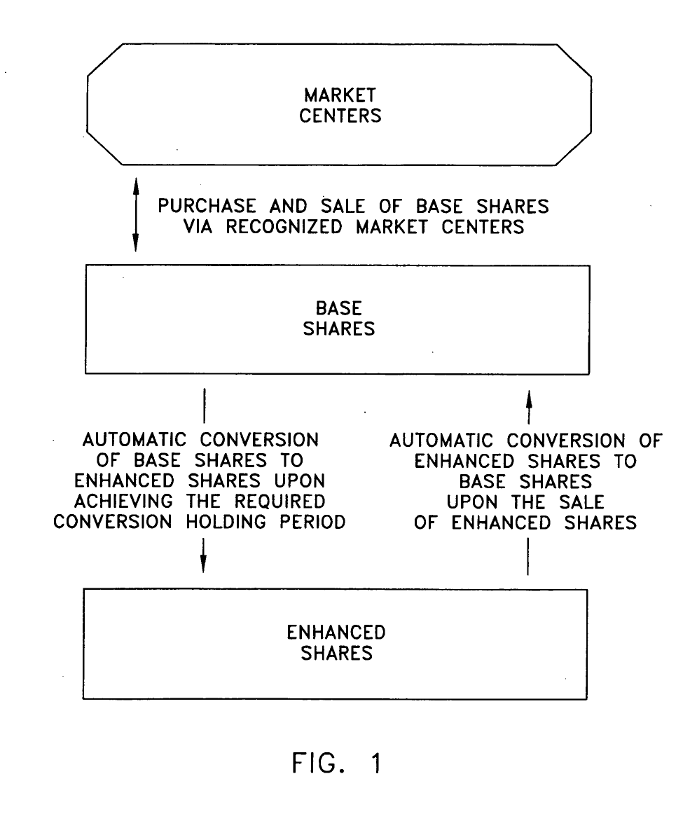

In the drawing, FIG. 1 is a chart illustrating the movement of shares in the market and the changes in benefits derived therefrom.

### DESCRIPTION OF THE PREFERRED EMBODIMENTS

This invention is primarily useful to any corporation that currently pays a dividend on its common stock or whose management wishes to begin doing so, and whose common stock is already publicly listed/traded or whose management wishes to publicly offer its common stock. It is also potentially useful to corporations that do no pay dividends but want to reward longer-term shareholders with other premium terms.

In use of this invention, a corporation originates (but does not list for trading) one or more new “classes” of common equity securities, referred to hereinafter as “enhanced shares”, that have a higher dividend rate per share than the corporation's traditional common shares, and/or other enhanced characteristics, such as special voting rights, but that have the same priority as common shares with respect to their residual claim on its income assets. The corporation simultaneously exchanges its traditional common shares for a combination of (a) enhanced shares and (b) modified version of traditional common shares, referred to hereinafter as “base shares”. The key difference between base shares and traditional common shares is that base shares will automatically convert to one of the new classes of enhanced shares after a beneficial owner owns them for the holding period specified by the issuing corporation. Enhanced shares are freely convertible back into base shares at any time, usually only upon their sale.

For illustrative purposes, one might consider a simple implementation of the invention wherein a corporation that is already public and paying a dividend issues a single class of enhanced shares that pays a premium dividend and exchanges its traditional common shares for base shares.

In order for an issuing corporation to use this invention, the issuing corporation performs the following actions: issuance, ongoing maintenance, modification of terms, and retirement.

Issuance

1. Establish the proposed dividend rate, or other premium terms, of the new enhanced shares, and the required holding period for base shares to convert to enhanced shares.
2. Draft, file and follow through with the US SEC, or the equivalent securities regulation authorities in countries other than the United States of America, the required securities offering documents to (a) originate the new enhanced shares, and (b) undertake an exchange offer for the holders of the existing traditional common shares. The origination filing will specify, among other things, the initial premium terms of the enhanced shares, and b) the length of time a beneficial owner is required to hold the base shares before they automatically convert to the enhanced shares. The exchange offer filing will similarly specify the terms of the base shares to be received in exchange for the traditional common shares, including the indicated dividend rate and holding period required for conversion.
3. Make arrangements with service providers to support the new securities.
4. Upon effecting of the registrations, distribute proxy materials to existing shareholders describing the terms of the new securities to be originated and the terms of the exchange offer.
5. Conduct the origination and exchange offers at the times established in the proxy materials. While it would be irrational not to exchange one's share, it is possible that not all shares will be tendered for exchange and that the issuer may not be able to fully retire the traditional shares. An alternative method of effecting the exchange is to conduct a shareholder vote, the results of which will be binding on all shareholders. This latter method may be more cumbersome but would ensure that the traditional shares are fully retired.
   Ongoing Maintenance: Conversion Between Classes and Dividend Payments

Once an issuer finishes originating enhanced shares and exchanging its traditional common shares for base and/or enhanced shares, that issuer and its service providers will administer the new securities in a similar manner to its traditional common shares, but with important differences described herein below and shown graphically in FIG. 1.

An integral part of this invention is the journaling function between base shares and enhanced shares that is necessitated by the conversion feature. The registrar will track the length of ownership and provide the depository with an accurate record of the number of shares of each kind of security held by each holder.

Similarly, when a holder of enhanced shares sells some number of them, the depository and registrar will be required to coordinate their actions in order to ensure that the required conversion back to base shares takes place and that the holdings are adjusted properly.

Subject to approval by the US Internal Revenue Service, or its foreign counterparts for holders in countries other than the United States of America, the original cost basis and purchase date of base shares will carry over upon conversion to enhanced shares and back again to base shares upon sale.

Investors wishing to sell enhanced shares will not need to actually convert their shares into base shares prior to sale. This invention includes an automatic conversion feature as part of the clearance and settlement process. If an investor holds both base shares and enhanced shares, the default assumption will be that the investor intended to sell the former, unless explicitly instructed otherwise (for example, if a better tax result is expected to be obtained selling the latter).

Given that holdings can be accurately tracked, the actual payment of dividends should not require any special mechanisms.

Modification of Terms

It is anticipated that corporations using this invention will retain for both their base shares and their enhanced shares the flexibility that they have historically enjoyed with their traditional common equity with respect to the frequency, timing, and amount of dividends paid.

It is also anticipated that corporations using this invention will want the flexibility to be able to modify the required holding period base shares before they convert into enhanced shares. Thus, a part of this invention is to include in the security registration documents the terms under which, and the mechanism by which, such a change may occur. This ability would have to be used very judiciously by the issuer in order to maintain the integrity of the issuer's program.

Termination and Retirement

Subject to having the authority in the relevant constituent documents, an issuing corporation using this invention may choose to terminate its enhanced shares program. It would effect this termination by exchanging all outstanding base shares and enhanced shares back into traditional common equity shares. As such, the mechanism for and terms of such a “termination exchange” will be included as part of the practice of the invention.

Features and Variations

Waiver of holding period by issuer upon initiation: Upon its initial use of this invention, the issuer may choose to issue enhanced shares only to holders of duration greater than, or equal to, the specified holding period. For example, if the enhanced holding period is one year, only traditional common equity shareholders who have held their shares for one year or longer will initially receive enhanced shares. Alternatively, the issuer may choose to waive the holding period for the initial exchange offer and convert all traditional shares into enhanced shares upon the completion of the offering. Any base shares purchased in the open market thereafter would then be subject to the normal holding period requirement.

Enhanced shares as a means of initiating or increasing a dividend: Companies may choose to effect a dividend increase by issuing enhanced shares. Similarly, this invention represents a novel way for companies to initiate dividends.

Use of invention in conjunction with an initial public offering: For companies whose shares are not yet publicly traded, enhanced shares can be offered in an initial public offering (IPO). However, base shares would still have to be listed as part of the IPO in order to accommodate sales by holders of enhanced shares. One benefit of this approach to going public is that an IPO of enhanced shares may exhibit dramatically reduced speculative price volatility and trading volume, including especially the high share volume generated by the controversial practice of “flipping”.

Shorting enhanced shares: Enhanced shares cannot be “shorted” because they are not listed for public trading.

Treatment of option holders: It is anticipated that, for holders of publicly listed/traded call options on a company's common equity, the holding period for enhanced shares eligibility will commence upon the exercise of such options. However, other arrangements may be both feasible and desirable.

Multiple enhanced yield classes: Enhanced shares can be “daisy-chained” to create multiple holding period classes. For example, a company may choose to issue two classes of enhanced shares, one of which is issued to shorter duration holders (for example, 1 to 3 years) called “Class 1”, and the other of which (called “Class 2”) is issued to holders of Class 1 enhanced shares on the third anniversary of ownership. Class 2 enhanced shares would offer terms better than its Class 1 counterparts.

Other enhanced properties: The foregoing discussion focuses on properties of dividend yield and shareholder votes as premium terms for the enhanced shares. However, this focus is not meant to limit the generality of the invention. Enhanced shares can possess other premium terms.

Dividend payment mechanism: In terms of actual dividend payment mechanism (i.e., how cash is paid by the issuer to the shareholder), enhanced shares will leverage the systems and procedures (i.e., transfer agents, etc.) that are currently used to distribute dividend payments. Issuing companies will negotiate with their transfer agents a price for the additional administrative burdens and/or other costs that the new system imposes.

Other securities: While this invention disclosure has focused on the application of the invention to common equity securities, it can also be applied to other types of securities. For example, bonds can pay differential rates of interest and/or have differing levels of seniority based on time of ownership. Convertible securities can have differential conversion premiums. Preferred securities can have differing dividend rates and seniority. This invention has the potential to benefit the full spectrum of corporate securities.

Alternative implementation of the invention: This invention may be implemented without the use of legally separate securities. Given that the registrar of a company's securities can accurately track the ownership date of each holder, the company may simply be able to declare a multi-tiered payment based on length of ownership. For example, a company may declare a common stock dividend of the form “x dollars per share for the holders with ownership date equal to or earlier than a selected date, and y dollars per share with an ownership date later than the selected date, where x, y, and the selected date are specified by the company. This alternative mechanism is potentially applicable to any type of security, for example, common stock, preferred securities, bonds and other types of fixed income securities.

Under this implementation, it is possible to sell short both lower- and higher-yielding securities. Borrowers of a company's securities for the purpose of selling them short may insist on knowing the amount of substitute payment for which they would be liable if they were to have an open short position over a record date. Therefore, it may be desirable for lenders to develop novel payment liability notification methods for borrowers of securities as a result of this alternative implementation.

A concern facing those attracted to the enhanced shares invention is that of “gaming”, i.e., any device by which an investor may defeat the holding period requirements for obtaining the higher dividend yield and/or other premium terms. There are a number of means by which this may be attempted, none of which seems likely to succeed.

At first glance, an Exchange Traded Fund (“ETF”) that holds a single enhanced yield stock appears to be an intriguing potential vehicle for defeating the holding period requirement. Under this scheme, the underlying trust holds and obtains the benefit of enhanced shares, while holders of the publicly traded trust units can buy and sell them anytime. However, an examination of the mechanics of ETFs quickly reveals their unsuitability for this purpose. First, for any company not offering enhanced shares from Day 1, the ETF sponsor would have to hold base shares for the full holding period before being able to offer any kind of benefit. Second, on any day that the trust experienced a net decrease in publicly traded units, the number of underlying enhanced shares would by definition decrease. Third, the trust could never grow “organically” through the unit creation mechanism because enhanced shares are non-transferable—it could only grow by “incubating” more enhanced shares. Fourth, investors would still have to satisfy the holding period provisions for dividends received and would experience a “yield penalty” due to the operating expenses of the ETF. For these reasons, the ideal of using ETFs to defeat the purpose of enhanced shares appears to be impractical.

Similar reasoning suggests why investors will not attempt to “risklessly” obtain the benefit of enhanced shares by purchasing then hedging their ownership of common shares. Investors are unlikely to incur the considerable cost of going “short against the box”, hedging with so-called “single stock futures”, or buying puts on a stock simply to obtain the enhanced yield in the future, however, they may use such methods to hedge short-term price moves. The initial decision to buy a stock for investment purposes (as opposed to speculative purposes) must ultimately be driven by an assessment of the issuer's earning power over time.

Hedging strategies may also run afoul of so-called “tax straddle” rules and other IRS regulations for determining holding periods, which in turn dictate capital gain/loss character and dividend treatment for tax purposes. These regulations are likely to serve as strong deterrents to investors attempting to hedge their positions.

While other ideas to defeat the purpose of enhanced shares will most likely be tried, the issuer's ability to shape the policies and rules governing the terms of their enhanced shares represents a significant deterrent to such efforts. For example, a blunter variant of the ETF scheme described above is as follows:

An issuer announces it is initiating an enhanced shares program and will offer existing shareholders as of a certain record date a one-for-one exchange.
A financial services firm purchases 10 million base shares the day before record date and places them in a unit trust, then issues (and perhaps lists) certificates, each of which represents a claim on one base class common share, plus 80% of the enhanced shares dividend.
Such a trust can be highly leveraged since there is virtually no risk exposure for the sponsor of such a program. For the moment, further suppose that although unlikely, the cost of financing the position is actually less than the 20% share of the enhanced shares dividends received and that this scheme would actually make money.

The issuer has a number of possible tools at its disposal to defeat such a scheme. First and perhaps most powerfully, it can set the terms of its program in such a way as to make the scheme uneconomic. Second, it can petition the SEC or other regulatory authorities not to approve the trust. Third, the issuer can reserve the right under the terms of offering to force conversion to base shares of any holder who can be shown to be trying to defeat the intent of their enhanced shares program.

In order to help reduce any additional record keeping burden that enhanced share may entail, it is envisioned that such shares will be issued in “book entry” form only and/or that the enhanced shares benefit may only be made available to book entry holders of the base class equity.

A quality database of the terms of each user's program and a mechanism for publicizing changes thereto will be important for the success of enhanced shares. Given the widespread availability of the Internet and other media, this goal should be readily achievable.

On average, a company should expect to pay a smaller amount of total dividend dollars when its business performance slows; holders sell its stock in response. By the same token, increasing business performance will most likely increase the stability of the ownership base, thereby increasing the amount of total dividend dollars paid out. This self-adjustment mechanism could be highly attractive to issuers, especially those whose dividend coverage ratios are lower.

The main similarity between (a) the use of this invention, i.e., an enhanced shares/base shares program, and (b) the use of a combination of traditional preferred and common stock by a company, is that enhanced shares and preferred shares will often pay a higher dividend than base shares and traditional common shares, respectively. However, this superficial similarity should not distract from the, key innovation of this invention, which is the conversion of base shares to enhanced shares on the basis of time owned. In this crucial respect, the two approaches are totally distinct. Moreover, preferred shares are by definition senior to common shares in a company's capital structure with respect to their claim on assets and they often have legal priority with respect to the payment of dividends. Enhanced shares do not enjoy such advantages. Lastly, it should be noted that preferred/common structures are static, while the enhanced shares/base shares structure is highly dynamic.

For quite some time, companies have offered multiple classes of common equity based on differences in voting rights (Differential Voting Right Securities or DVRs). In most if not all cases, all classes are publicly traded. Various classes of equity are usually distinguished by letters that are appended to the end of the common stock symbol (e.g., “NYT/A”). Media companies, such as newspaper publishers, have been the most frequent users of this ownership structure, which is designed primarily to more closely guard control of the issuing company. The enhanced shares concept is entirely different (perhaps even antithetical) in both purpose and mechanics. First, the purpose of enhanced shares is to enhance long-term shareholder value both by rewarding true investors (as opposed to speculators) in a company's shares and by reducing the level of speculative volatility. By contrast, DVRs are issued primarily to achieve ownership control objectives. Enhanced shares can only be obtained by achieving a stated ownership period and, by definition, are not publicly traded. Conversions between enhanced shares and base class equity are predictable and automatic, whereas any class conversions between DVRs are usually episodic and require the holder to take affirmative action.

Preferred Equity Redemption Cumulative Stock (“PERCS”) represent a form of preferred equity, and in that respect alone are markedly different from enhanced shares, which are purely common equity. Furthermore, PERCS are typically limited-lifetime securities, while enhanced shares are perpetual. The conversion of PERCS into common equity at the end of their lifetimes brings about a change in the issuer's capital structure and occurs on terms that vary according to the price of the underlying common equity. PERCs are intended either as a capital-raising or a restructuring vehicle. None of these terms applies to enhanced shares, which are true common equity shares whose main purpose is to enhance shareholder value by rewarding long-term investment.

Dividend Reinvestment Programs (“Drips”) offer investors the opportunity to use cash dividends to purchase additional shares of a company's stock on a convenient and low-cost basis (usually “free”). Some companies offer a slight price discount on shares purchased (up to 10% of the dividend amount, but usually much less) as an inducement to participate in such programs.

While arguably the broad aim of enhancing shareholder value is the same, the method, features and scope of Drip programs are all very different from enhanced shares. At the most fundamental level, a Drip program does not involve a new class of common equity nor does it involve a true yield differential. It is primarily a voluntary, administratively convenient way for investors (typically retail) to purchase additional shares of a company's stock. Any yield differential enjoyed by the Drip participant, if any, is minuscule compared to the expected magnitude of yield differential offered through enhanced shares. Second, there is no time-based component: Drip participants need only register with the issuers or their agents to participate. Third, issuers satisfy Drip purchases through the direct issue of shares, which may be dilutive. Fourth, investors are by definition required to increase their holdings of the issuer's common equity as a condition of participation. In summary, Drip programs are essentially retail-oriented reinvestment programs with no real yield differential.

Although it would be difficult to confuse the structure and purpose of enhanced shares with those of Americus Trusts and related concepts, such as Unbundled Stock Units (“USUs”), it is worth enumerating the differences between them. Americas Trusts were invented as a novel means to partition into two parts the claims that the owner of a traditional common equity share enjoys. The first part, known as the “PRIME” (Prescribed Right to Income and Maximum Equity), represented title to the vote, the dividend (less an administrative fee), and price appreciation up to a certain price (the “strike price”). The second part, known as the “SCORE” (Special Claim on Residual Equity) represented a claim on price appreciation in excess of the strike price. These securities were devised as a convenient means for investors to tailor their risk/reward profile relative to ownership of traditional equity securities and are more akin to equity derivatives strategies such as “covered call writing”. In fact, the payout profile of these securities can by synthesized without much difficulty through the use of options. The underlying legal structure was a trust of limited duration (5 years) and the issuing company had no participation on the program. The trusts were created by existing shareholders tendering their shares into it in exchange for units consisting of one PRIME and one SCORE for each share tendered. The inducement for a holder to tender shares was the prospect that an “optionality” premium in the price of PRIME plus SCORE would develop relative to the underlying equity, and that an arbitrage profit could be earned by selling off the pieces at a premium and repurchasing the underlying equity. The motives and methods of this program, therefore, are patently different from those of the enhanced shares program.

Dividend “STRIDES” are simply a mechanism by which dividend payments can be “stripped” from the underlying security and two resulting securities offered. They are analogous to Treasury “STRIPS”, through which treasury bonds are split into “interest only” and “principal only” sub-securities. Once again, both the purpose and methods of these mechanisms are completely different from enhanced shares. STRIDES operate on existing securities, which are presumably held as collateral against the two components that are subsequently issued, and do not directly involve the issuer at all. Furthermore, their reason for existence is to provide substantially different payoff profiles to investors, whereas the reason for enhanced shares is to create shareholder value and reward tenure of ownership. Lastly, unlike enhanced yield securities, there is no holding period-based element to them.

Accordingly, there is provided a new method for encouraging extended holding periods of equity shares, and other securities, by applying to the shares or securities a benefit contingent upon the length of time the shares or securities are retained by an owner thereof.

It will be understood that additional changes in the details, steps and arrangements described and illustrated herein, may be made by those skilled in the art within the principles and scope of the invention as expressed in the appended claims.

1. A method for encouraging extended holding periods of securities, the method comprising applying to the securities a benefit contingent upon a selected length of time in which the securities are retained by an owner of the securities.

2. The method in accordance with claim 1 wherein an issuer of the securities having the securities publicly held exchanges for the publicly held securities base shares which automatically convert to enhanced shares upon expiration of the selected length of time by the owner of the base shares, the enhanced shares providing the benefit.

3. The method in accordance with claim 1 wherein an issuer of the securities having the securities publicly held effects a change on its books wherein the securities publicly held by the owner thereof for less than the length of time are converted to base shares and the securities held by the owner thereof for the selected length of time are converted to enhanced shares, the enhanced shares providing the benefit.

4. The method in accordance with claim 1 wherein an issuer of the securities having securities publicly held exchanges for the securities having been held by the owner thereof for the selected length of time enhanced shares which provide the benefit.

5. The method in accordance with claim 1 wherein an issuer of the securities having securities publicly held effects a change on its books wherein the securities held by the owner thereof for the selected length of time are provided with the benefit.

6. The method in accordance with claim 1 and comprising the further step of applying to the securities an additional benefit contingent upon a selected additional length of time the securities are retained by the owner of the securities.

7. The method in accordance with claim 1 wherein the securities comprise a selected one of equity shares, bonds, convertible securities, and preferred securities.

8. The method in accordance with claim 1, wherein the step of applying the benefit comprises applying a specified dividend payment when a period of ownership reaches the selected length of time.

9. The method in accordance with claim 1, wherein the step of applying the benefit comprises applying a specified voting right when the period of ownership reaches the selected length of time.

10. A method for encouraging extended holding periods of equity shares, the method comprising applying to the equity shares a benefit contingent upon a selected length of time in which the equity shares are retained by an owner thereof.

11. The method in accordance with claim 10 wherein the benefit comprises at least one of increased interest, increased dividends, increased voting rights, and additional equity shares.

12. The method in accordance with claim 10, wherein the step of applying the benefit comprises applying an increased dividend payment, when a period of ownership reaches the selected length of time.

13. The method in accordance with claim 10, wherein the step of applying the benefit comprises applying a specified voting right, when a period of ownership reaches the selected length of time.

14. A method for encouraging extended holding periods of equity shares, the method comprising:
assigning to each of the shares a specified benefit due to the owner of the share; and
increasing the benefit in accordance with a specified time period of ownership by the owner.

15. The method in accordance with claim 14 wherein an issuer of the equity shares having the equity shares publicly held exchanges for the equity shares publicly held base shares which automatically convert to enhanced shares upon expiration of the specified time period of ownership by the owner, wherein the enhanced shares entitle the owner to the benefit.

16. The method in accordance with claim 14 wherein an issuer of the equity shares having the equity shares publicly held effects a change on its books wherein the equity shares publicly held by the owner thereof for less than the specified time period of ownership are converted to base shares and the equity shares held by the owner thereof for the specified time are converted to enhanced shares, the enhanced shares providing the benefit.

17. The method in accordance with claim 14, wherein the step of applying a specified benefit comprises applying a specified dividend payment, and the step of increasing the benefit comprises raising the dividend when the period of ownership reaches the specified time period.

18. The method in accordance with claim 14, wherein the step of applying a specified benefit comprises applying a specified voting right, and the step of increasing the benefit comprises increasing the voting right when the period of ownership reaches the specified time period.

19. A method for increasing the value of a security issued or to be issued by an issuer and held or to be held by an owner, so as to encourage retention of the security by the owner, the method comprising the steps of assigning to the security a specified first benefit, and a specified second benefit more valuable than the first benefit, and specifying a selected time period between a first date on which the owner obtains the security and a second date following the first date and on which the owner still retains the security acquired on the first date, for the second benefit to be realized.

20. The method in accordance with claim 19 wherein the security comprises an equity share and the first benefit comprises a selected one of a dividend and a voting right, and the second benefit comprises a selected one of an increased dividend and an increased voting right.

21. The method in accordance with claim 19 wherein upon a selected one of (1) election by the owner, and (2) sale of the security by the owner, the security reverts from providing the second benefit to providing the first benefit.

22. A method for generating certificates of securities issued for acquiring funds by an issuer in exchange for the certificates, the method comprising the steps of:
a. inputting a legend indicating that the issuer will distribute base benefits to persons who own the certificates;
b. inputting a second legend indicating that the issuer will distribute enhanced benefits to persons who own the certificates for an indicated length of time, the enhanced benefits being of greater value to the persons than the base benefits; and
outputting the inputs from the steps a and be onto the certificates.
